(19) United States
(12) Patent Application Publication
(10) Pub. No.: US 2005/0125739 A1
(43) Pub. Date: Jun. 9, 2005

(54) Virtual desktop manager system and method

(76) Inventors: Jeffrey W. Thompson, Champaign, IL (US); Matthew S. Klahn, Savoy, IL (US); Michael Jay Swanson, Savoy, IL (US); Darrel C. Goeddel, Champaign, IL (US); Matthew G. Byron, St. Louis, MO (US)

Correspondence Address: ROBERT S. LIPTON, ESQUIRE, 201 NORTH JACKSON STREET, P. O. BOX 934, MEDIA, PA, 19063-0934, US

(21) Appl. No.: 10/995,022

(22) Filed: Nov. 22, 2004

Related U.S. Application Data
(60) Provisional application No. 60/523,615, filed on Nov. 20, 2003.

(51) Int. Cl. G06F 3/00

(52) U.S. Cl. 715/778; 715/779; 715/768

(57) ABSTRACT

The present invention comprises a method and computer implemented system for presenting multiple virtual desktops on a display of a computer system. A “pager” window is displayed on a desktop (either real or virtual) which comprises multiple subpanes, each of which contains a scaled virtual desktop having dimensions that are proportional to, but less than the dimensions of a corresponding virtual desktop. Each scaled virtual desktop provides a representation of the corresponding full-size virtual desktop that would display one or more application windows whose content may optionally be replaced by the icon designating the application program or data file displayed therein, for sake of visual clarity. The present invention also provides a mechanism for varying the background image of virtual desktop, and thus, of each scaled virtual desktop pane, in addition to a number of enhancements to the user interface for controlling the virtual desktop environment including transparency hiding of the pager window, constant aspect ratio scaling of the pager window, mouse desktop changing with corner exclusion, display and interaction with window lists, individual pop up menus for windows, starting desktop selection, a method for moving windows between virtual desktops, a method to override virtual desktop behaviors, a method for placing child windows on the same desktop as the parent window, notification of desktop changes, tracking topmost application on other desktops, sticky monitors, and API remote control.

### RELATED APPLICATIONS

The present application claims priority of U.S. Provisional Application Serial. No. 60/523,615, filed Nov. 20, 2004, entitled “Virtual Desktop Manager System and Method”.

### TECHNICAL FIELD OF THE INVENTION

This invention relates generally to the field of graphical user interfaces, and more particularly, to virtual desktop areas of a graphical user interface.

### BACKGROUND OF THE INVENTION

Windowing operating environments share certain metaphorical conventions. Chief among these is the “desktop” metaphor, wherein the computer screen is likened to a physical desktop, and objects (icons) that represent files, folders (collections of files), and devices (printers, storage media, etc.) are visually arranged on this “desktop” to permit a user to access them conveniently. However, this electronic desktop may become a mess, as it becomes crowded with many icons arranged in ways that make it difficult to locate those relevant to a particular task or application program. Added to this confusion is the fact that program windows also appear over the desktop space, obscuring both icons and other windows.

In older, less powerful computers with limited ability to efficiently run multiple application programs simultaneously, the level of confusion was generally limited by the capability of the hardware to remain useful under heavy load. With more modern systems having large hard disks, random access memory, and fast network connections, confusion has become the norm for most desktop users.

Early attempts to provide clarity in multitasking operating environments used concepts of multiple virtual screens, each dedicated to a single application program. Apple Computer, Inc. (Cupertino, Cailf., US) provided such an environment in its “MultiFinder” program in 1987. Other software approaches have provided ways of changing focus within the desktop environment by making invisible those windows and objects not associated with the foreground task. Still others have enlarged the desktop by treating the computer monitor as a viewport into a larger graphical desktop, and allowing scrolling to present the contents of the desktop within the monitor's dimensions.

A Virtual Desktop Manager is a program that provides the user with multiple desktops by “virtualizing” the normal desktop, and as a result each of those virtual desktops may be better organized and more productive than the original (single) one. Under certain conditions, a virtual desktop manager may be more effective than having multiple monitors, which require substantial investments in hardware, and may not be supported by the underlying operating system.

Certain operating systems incorporate one or more Virtual Desktop Managers (such as BeOS) In other instances, a windowing subsystem may provide such capabilities (such as those in Linux, FreeBSD, and OpenBSD, where windows managers under X Windows have been used.)

In systems running Microsoft Windows, there are many Virtual Desktop Manager programs available as additions to the operating system. Among these programs are Microsoft Virtual Desktop Manager for Windows XP (Microsoft Corp., Belleview, Wash., US), DeskSelect (GBS Design, Inc. London, ON, CA), Virtual Desktop Manager (Shelltoys, London, UK), MultiDesk (Digital River, Inc.) and many more too numerous to mention. Each of these has, in addition to the basic ability to manage more than one virtual desktop, various additional functions intended by their developers to aid in management of the virtual desktop environment.

The Apple Macintosh OS X environment inherently supports multiple real desktops, depending on the number of monitors connected to the computer's video interfaces. In addition, Apple provides the X11 windowing environment, and thus, for application programs that use X11, a variety of Virtual Desktop Manager programs are available. Heretofore, Mac OS X Virtual Desktop Managers of the prior art have been adaptations of those found on other Unix-derived systems. Because of the complex interactions between the underlying Unix-derived core of Mac OS X and its graphical user interface, such software “ports” typically lack important functions, or fail to function in all instances with all software.

An example of a desktop 100 is shown in FIG. 1, where one or more application windows 102, and object icons 104 are displayed on the desktop 100. Each application window is associated with a software program (application) designed to assist in the performance of a specific task, such as word processing, web browsing, accounting, or electronic mail. The desktop 100 includes a dock 108 comprising a plurality of icons, for causing one or more applications having windows 102 to be launched in response to a user action, and a menu bar 106 which contains titles of drop-down menus associated with applications, system management functions, and the like.

When a sufficient number of application windows 102 have been created and shown on the desktop 100, the desktop 100 may become confusingly cluttered. As a result, a plurality of virtual desktops are provided by the present invention to expand the size of the desktop 100. Each virtual desktop may have the same size as the desktop 100.

Using virtual desktops allows the group of application windows 102 to be dispersed and organized throughout the virtual desktops, thereby reducing the cluttered appearance. Each virtual desktop may be accessed in a variety of ways, as detailed in the User Guide which is included in the CD-ROM Appendix (contents ©2003 Code Tek Studios, Inc. All Rights Reserved), and is incorporated herein by reference. Among the access methods are: clicking in a menu in the menu bar 106 (here labeled “[Web Browsing]” which is a user-definable name given to each virtual desktop), clicking in a sub-pane of pager window 110, moving to a screen edge, by typing “hot keys”, and the like.

### SUMMARY OF THE INVENTION

In accordance with the present invention, a method and computer implemented system for presenting multiple virtual desktops on a display of a computer system for previewing by a user are provided. A “pager” window 10 is displayed on the screen. Pager window 110 comprises multiple subpanes, each of which contains a scaled virtual desktop having dimensions that are proportional but less than the dimensions of a corresponding virtual desktop. Each scaled virtual desktop provides a representation of the corresponding full-size virtual desktop that would display, albeit at a smaller scale. For example, if the corresponding full-size virtual desktop has one or more application windows that are shown on the full-size virtual desktop, the scaled virtual desktop would display one or more scaled application windows that correspond to the one or more application windows shown by the corresponding full-size virtual desktop. The contents of the application windows may optionally be replaced by the icon designating the application program or data file displayed therein, for sake of visual clarity.

The present invention may also provide a mechanism for varying the background image of a virtual desktop. The use of differing backgrounds allows a user to visually identify the different virtual desktops as well as the application windows that are running on those virtual desktops. It also provides a number of enhancements to the user interface for controlling the virtual desktop environment including transparency hiding of the pager window, constant aspect ratio scaling of the pager window, mouse desktop changing with corner exclusion, display and interaction with window lists, individual pop up menus for windows, starting desktop selection, a method for moving windows between virtual desktops, a method to override virtual desktop behaviors, a method for placing child windows on the same desktop as the parent window, notification of desktop changes, tracking topmost application on other desktops, sticky monitors, and API remote control.

### BRIEF DESCRIPTION OF THE DRAWING

The foregoing aspects and many of the attendant advantages of this invention will become more readily appreciated as the same become better understood by reference to the following detailed description, when taken in conjunction with the accompanying drawings, wherein:

FIG. 1 is a screen shot illustrating a desktop of a graphical user interface according to the present invention.

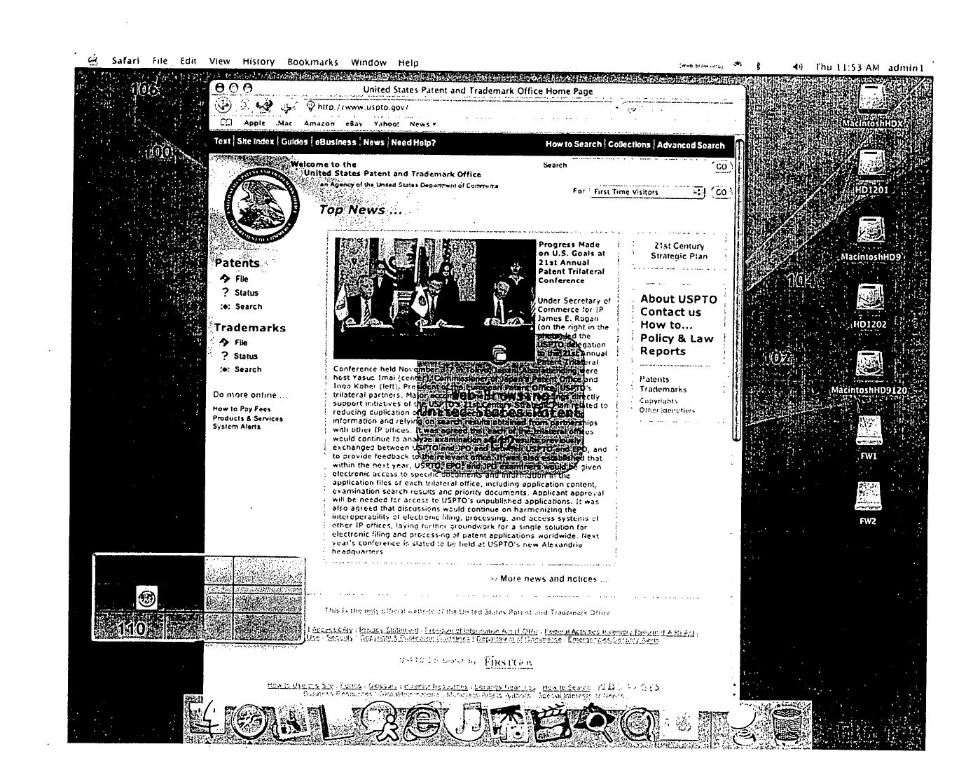

### DETAILED DESCRIPTION OF THE INVENTION

The invention is disclosed in full in the source code appendix CD-ROM, which is incorporated herein by this reference. A directory thereon entitled “CTVDCode” contains source code and related resources necessary to compile the present invention under Apple Macintosh OS X Version 10.2.8 (Apple Computer, Inc., Cupertino, Calif., US). Reference is made to the Source code for a complete disclosure of the invention.

Transparency Hiding of Pager Window

Pager windows 110 often take up a significant amount of screen “real estate” (area.) In order to allow the user to have the ability to use the pager without having it persistent on the screen, the present invention implements a new strategy for handling the pager window 110. Whenever the pager window 110 is not in use, it automatically becomes transparent to a user-defined degree. Transparency may occur immediately, or slowly happen over time, as determined by the user. A pager window 110 is considered active whenever the user's mouse cursor hovers over the area of the screen occupied by pager window 110 for a predetermined and user-controllable time period. Once the mouse remains in this area for the time period, the pager will lose its transparency and appear again. This appearance may take place over time as a gradual increase in transparency, or immediately, again, under user control.

Aspect Ratio Scaling of Pager

Different users have unique requirements for the absolute or relative size of a pager window 110. In order to meet this requirement, the present invention allows a user to scale the size of the pager window 110, while maintaining a constant aspect ratio of the pager.

Mouse Desktop Changing

While many virtual desktop implementations of the prior art provide a method to change from one virtual desktop to another by moving the mouse to the edge of the screen, the present invention uniquely prevents the user from inadvertently changing desktops when the mouse is in one or more the corners of the screen. This method determines when the mouse pointer is near the corner of a screen and determines whether to cause a virtual desktop change to take place. The method may disallow desktop changes in any of the corners, or may only disallow them in corners that are being used for other application activations such as a screen saver or Expose hotspot. This method also allows desktops to be changed by placing the mouse near the edge of the screen as is done in several virtual desktop implementations of the prior art, but prevents inadvertent activation or initiation of multiple system functions with a single mouse action (e.g., desktop change and simultaneous screensaver activation.)

Display and Interaction with Window List

The system of the present invention provides a novel method for viewing the windows display ed in each virtual desktop and for interacting with them. The present invention implements a menu in menu bar 106 that contains a list of virtual desktops that is available to be switched to. The user may select one of these desktops and switch to it. In addition, each item in the desktop menu is provided with a submenu that contains a list of windows on each virtual desktop. The user may then select one of these windows and will then switch to the virtual desktop of that window, and automatically activate it.

Individual Pop Up Menus for Windows

The present invention provides a novel method for managing a window and its virtual desktop settings by allowing the user to press a configurable hot key when the mouse is hovering over a window. A virtual desktop management window that is tailored to the window the mouse is hovering over will be presented, and will allow the user to change that window's settings.

The present invention also provides a novel method in the pop up menu that allows the user to move an individual window to any chosen virtual desktop via the pop up menu, or to move all of the application's windows to any chosen virtual desktop. The destination virtual desktop is selected within this menu.

Starting Desktop Selection

The present invention provides a mechanism for setting the starting virtual desktop upon launch. Through a configuration option, the user may specify any virtual desktop as the default starting desktop when launching the virtual desktop manager application of the present invention. This differs from the prior art mechanism that forces the first desktop to always be the startup desktop.

A Method for Moving Windows Between Virtual Desktops

Virtual desktop systems of the prior art either allows no mechanism for moving windows between virtual desktops, or allows movement of windows through the graphical interface. The present invention implements new method for moving a window or a collection of all of a particular application's windows to another virtual desktop by clicking and hold the mouse button down on the title bar of a window and then changing virtual desktops via a hot key. Whenever a desktop change takes place with a hot key, the present invention determines if the mouse is down on the title bar of a window, and if so, it will then move the window to the new virtual desktop.

A Method to Override Virtual Desktop Behaviors

Behaviors in virtual desktop software are typically only changeable through a graphical configuration interface. To allow the user to temporarily suspend some virtual desktop behavior, the present invention implements an override hot key mechanism. This hotkey overrides the “focus follows mouse” feature, to allow changing desktops without changing the current application (normally the last active application on a desktop is made active when you switch to the new desktop), and overrides application desktop settings so that a new window shows up on the current desktop (applications can have their windows forced to a specific desktop, the override hot key temporarily disables this behavior).

A Method for Placing Child Windows on the Same Desktop as the Parent Window

Prior art virtual desktop implementations place new application windows either on the Current virtual desktop, or move them to another desktop based on a rule for that application. The present invention implements a method to detect child windows (windows such as alert panels, drawers, or sheets) and to place them onto the desktop of their parent window.

Notification of Desktop Changes

Some applications wish to be aware of virtual desktop behavior, and to facilitate this the present invention implements method for notifying applications whenever a new virtual desktop is selected.

Tracking Topmost Application on Other Desktops

In order to provide users with a more logical experience with virtual desktop software, the system of the present invention has the capability to track the last active application on each virtual desktop. Normally, virtual desktops will return the user to the topmost window on a virtual desktop. However, on Macintosh systems (and likely others) it is possible to have an application be active but not have any open windows. The present invention implements a method to track the last active application on a virtual desktop and make that application active again upon returning to that desktop, even if it does not have any windows present on that desktop.

Sticky Monitors

The present invention allows the user to determine whether all monitors besides the main monitor in systems having more than one real screen are “sticky”. If the other monitors are sticky, then these monitors will no longer be managed by the virtual desktop system of the present invention, and any window placed on them will always be seen. This may also be used to allow the user to select individual monitors to be sticky, rather than just selecting all monitors besides the main one. A configuration option is available in the GUI to allow the user to select whether they would like this behavior.

Remote Control

The present invention provides a mechanism for controlling all of the virtual desktop behavior through programmatic mechanisms (application program interfaces or APIs) in addition to the already existing manual controlling mechanisms a user can access via the graphical interfaces. These programmatic mechanisms include obtaining the current virtual desktop, changing virtual desktops, obtaining lists of windows for each virtual desktop, and moving windows between virtual desktops. In this way, applications software may plan for, and implement workflow environments that use virtual desktops directly.

In particular, the API may be used to manage the visibility of object icons on the virtual desktops. For instance, one or more sets of icons may be defined, and may be moved under control of the API or another application program to a particular virtual desktop, or may be made visible or invisible depending on the frontmost window, active (foreground) application, or another criterion. Similarly, when moving an application's windows to another virtual desktop, icons associated with that application may be assigned to an ad hoc icon set and moved to the target virtual desktop along with the application's windows. Alternatively, projects may be defined using commonly employed mechanisms such as operating system level file labels or the like, and all icons associated with a particular project or label may be moved to a target virtual desktop via an API call.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may be made in the details within the scope and range of equivalents of the claims and without departing from the spirit of the invention. The inventors further require that the scope accorded their claims be in accordance with the broadest possible construction available under the law as it exists on the date of filing hereof (and of the application from which this application obtains priority) and that no narrowing of the scope of the appended claims be allowed due to subsequent changes in the law, as such a narrowing would constitute an ex post facto adjudication, and a taking without due process or just compensation.

The Provisional Application referred to herein, including the CD which accompanied it, is incorporated herein by reference;

1. A computer implemented system for presenting multiple virtual desktops on a display of a computer system for previewing by a user which comprises:
a pager window having multiple subplanes, said subplanes having a scaled virtual desktop having dimensions proportional but less than the dimensions of a corresponding virtual desktop; and means for automatically causing said windows to become transparent to a user-defined degree at a user-defined rate.
